(19) United States
(12) Patent Application Publication
(10) Pub. No.: US 2015/0378726 A1
(43) Pub. Date: Dec. 31, 2015

(54) IMPLEMENTATION FOR A HIGH PERFORMANCE BCD DIVIDER

(71) Applicant: Oracle International Corporation, Redwood City, CA (US)

(72) Inventors: Christopher H. Olson, Austin, TX (US); Jeffrey S. Brooks, Austin, TX (US); Albert Danysh, Cedar Park, TX (US)

(21) Appl. No.: 14/317,691

(22) Filed: Jun. 27, 2014

(51) Int. Cl. G06F 9/30; G06F 9/38

(52) U.S. Cl. CPC G06F 9/3001; G06F 9/3802; G06F 9/30029

(57) ABSTRACT

Embodiments of an apparatus are disclosed for performing arithmetic operations on provided operands. The apparatus may include a fetch unit, and an arithmetic logic unit (ALU). The fetch unit may be configured to retrieve two operands responsive to receiving an instruction, wherein the operands include binary-coded decimal values. The ALU may be configured to scale a value of each of the operands, and then compress the scaled values of the operands. The compressed values of the operands may include fewer data bits than the corresponding scaled values. The ALU may be further configured to estimate a portion of a result of the operation dependent upon the compressed values of the operands.

### BACKGROUND

1. Technical Field

The embodiments disclosed within relate to integrated circuits, and more particularly, to processors and arithmetic operations.

2. Description of the Related Art

Processors are used in a variety of applications ranging from desktop computers to cellular telephones. In some applications, multiple processors or processor cores, may be connected together so that computation tasks may be shared among the various processors. Whether used individually, or as part of group, processors make use of sequential logic circuits, internal memory, and the like, to execute program instructions and operate on input data, which may be represented in a binary numeral system. Processors are often characterized by the size of individual data objects, such as, 16-bits, for example.

Modern processors typically include various functional blocks, each with a dedicated task. For example, a processor may include an instruction fetch unit, a memory management unit, and an arithmetic logic unit (ALU). An instruction fetch unit may prepare program instructions for execution by decoding the program instructions and checking for scheduling hazards. Arithmetic operations such as addition, subtraction, multiplication, and division as well as and Boolean operations (e.g., AND, OR, etc.) may be performed by an ALU. Some processors include high-speed memory (commonly referred to as “cache memories” or “caches”) used for storing frequently used instructions or data.

As the size of data objects increased, numbers could be represented in different formats allowing for greater precision and accuracy. The processing of such data objects may require multiple program instructions in order to complete a desired function. Utilizing dedicated arithmetic hardware, such as an ALU, may result in improved computation performance in some applications. The format of numbers being processed, however, may be specific to a given hardware ALU implementation. In such cases, additional program instructions may be required to allow different processor hardware to operate on a common set of data objects.

### SUMMARY

Various embodiments of an apparatus and a method for processing machine independent number formats are disclosed. Broadly speaking, a method and apparatus are contemplated in which an apparatus includes a fetch unit and an arithmetic logic unit (ALU). The fetch unit may be configured to retrieve a value of a first operand and a value of a second operand responsive to receiving an instruction, wherein the value of first operand and the value of the second operand may each include respective binary-coded decimal (BCD) values. The ALU may be configured to scale the value of the first operand and the value of the second operand to generate a first scaled value and a second scaled value, respectively. The ALU may also be configured to compress the scaled value of the first operand and the scaled value of the second operand to generate a first compressed value and a second compressed value, respectively. The ALU may also be configured to estimate a portion of a result of the operation dependent upon the first compressed value and the second compressed value.

In a further embodiment, the apparatus may include a lookup table, wherein the lookup table may include a plurality of entries. To estimate the portion of the result of the operation, the ALU may be further configured to select a given one of the plurlaity of entries dependent upon the first compressed value and the second compressed value.

In another embodiment, to estimate the portion of the result of the operation, the ALU may be further configured to determine a minimum possible value for the portion of the result and a maximum possible value for the portion of the result dependent upon the given one of the plurality of entries. In one embodiment, the ALU may be further configured to determine the portion of the result of the operation dependent upon the minimum possible value for the portion of the result and the maximum possible value for the portion of the result.

In a possible embodiment, the first scaled value and the second scaled value may each be greater than or equal to one and less than ten. In another embodiment, each entry of the plurality of entries may include a plurality of data bits, wherein each one of the plurality of data bits may occupy a respective one of a plurality of ordered data bit positions, wherein a data bit position of an active data bit may correspond to the portion of the result of the operation.

In one embodiment, to compress the second scaled value to generate the second compressed value, the ALU may be configured to compress a fractional portion of the second scaled value to generate a compressed fractional portion. A number of data bits included in the compressed fractional portion may be less than or equal to three.

### BRIEF DESCRIPTION OF THE DRAWINGS

FIG. 1 is a block diagram of an embodiment of a distributed computing unit.

FIG. 2 is a block diagram of an embodiment of a processor.

FIG. 3 is a block diagram of an embodiment of a processor core.

FIG. 4 illustrates a block diagram of an embodiment of a number format.

FIG. 5 illustrates a block diagram of an embodiment of another number format.

FIG. 6 illustrates a flowchart depicting an embodiment of a method for calculating a quotient of a division operation.

FIG. 7 is a table depicting values used in an embodiment of a method for calculating a quotient of a division operation.

FIG. 8 is an embodiment of a portion of lookup table used in a method for calculating a quotient of a division operation.

FIG. 9 illustrates a flowchart depicting an embodiment of a method for performing a division operation using a lookup table.

FIG. 10 is a flowchart illustrating an embodiment of method for estimating a quotient of a division operation.

FIG. 11 is a table showing an embodiment of a portion of a look-up table for estimating a quotient of a division operation.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph (f), interpretation for that unit/circuit/component.

### DETAILED DESCRIPTION OF EMBODIMENTS

In a computing system, numeric values may be stored and processed using various encodings of bit patterns. As such different processor implementations within the computing system may have different representations of a given numeric value, i.e., various numeric formats. Moreover, some processors may allow for multiple representations of numbers and these various numeric formats may require additional program instructions to perform numeric operations of numbers in a given format. These additional instructions may result in a reduction in computing performance. The embodiments illustrated in the drawings and described below may provide techniques for avoiding such reductions in computing performance when executing arithmetic operations on numbers represented in different numeric formats.

### Computing System Overview

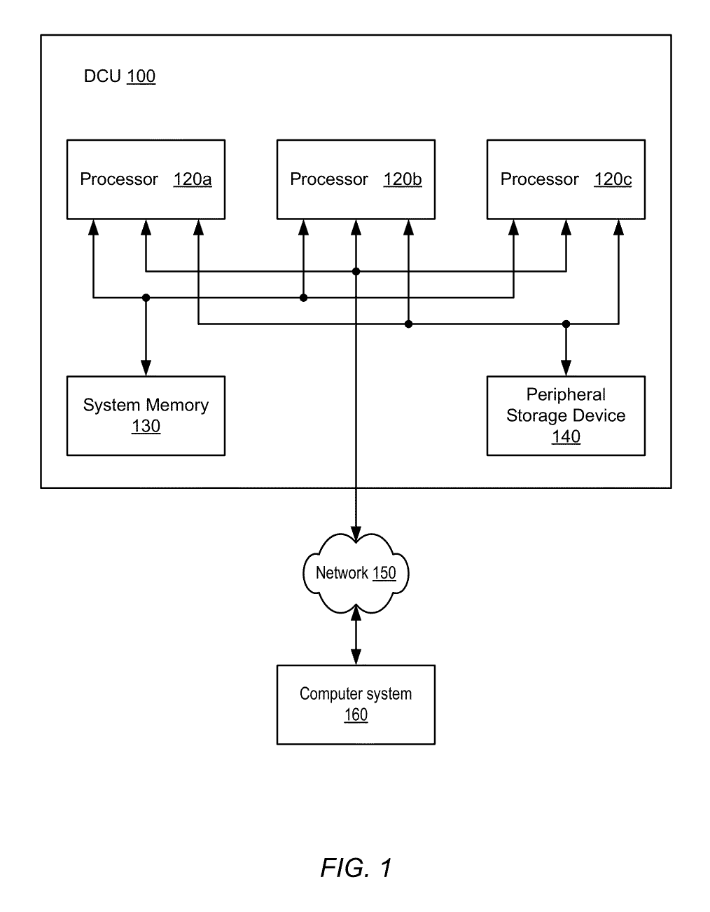

A block diagram illustrating one embodiment of a distributed computing unit (DCU) 100 is shown in FIG. 1. In the illustrated embodiment, DCU 100 includes a plurality of processors 120a-c coupled to system memory 130, and peripheral storage device 140. DCU 100 is coupled to a network 150, which is, in turn coupled to a computer system 160. In various embodiments, DCU 100 may be configured as a rack-mountable server system, a standalone system, or in any suitable form factor. In some embodiments, DCU 100 may be configured as a client system rather than a server system.

System memory 130 may include any suitable type of memory, such as Fully Buffered Dual Inline Memory Module (FB-DIMM), Double Data Rate or Double Data Rate 2 Synchronous Dynamic Random Access Memory (DDR/DDR2 SDRAM), or Rambus® DRAM (RDRAM®), for example. It is noted that although one system memory is shown, in various embodiments, any suitable number of system memories may be employed.

Peripheral storage device 140 may, in some embodiments, include magnetic, optical, or solid-state storage media such as hard drives, optical disks, non-volatile random-access memory devices, etc. In other embodiments, peripheral storage device 140 may include more complex storage devices such as disk arrays or storage area networks (SANs), which may be coupled to processors 120a-c via a standard Small Computer System Interface (SCSI), a Fibre Channel interface, a Firewire® (IEEE 1394) interface, or another suitable interface. Additionally, it is contemplated that in other embodiments, any other suitable peripheral devices may be coupled to processors 120a-c, such as multi-media devices, graphics/display devices, standard input/output devices, etc.

As described in greater detail below, each of processors 120a-c may include one or more processor cores, co-processors and cache memories. In some embodiments, each of processors 120a-c may be coupled to a corresponding system memory, while in other embodiments, processors 120a-c may share a common system memory. Processors 120a-c may be configured to work concurrently on a single computing task and may communicate with each other to coordinate processing on that task. For example, a computing task may be divided into three parts and each part may be assigned to one of processors 120a-c. Alternatively, processors 120a-c may be configured to concurrently perform independent tasks that require little or no coordination among processors 120a-c.

The embodiment of the distributed computing system illustrated in FIG. 1 is one of several examples. In other embodiments, different numbers and configurations of components are possible and contemplated.

### Processor Overview

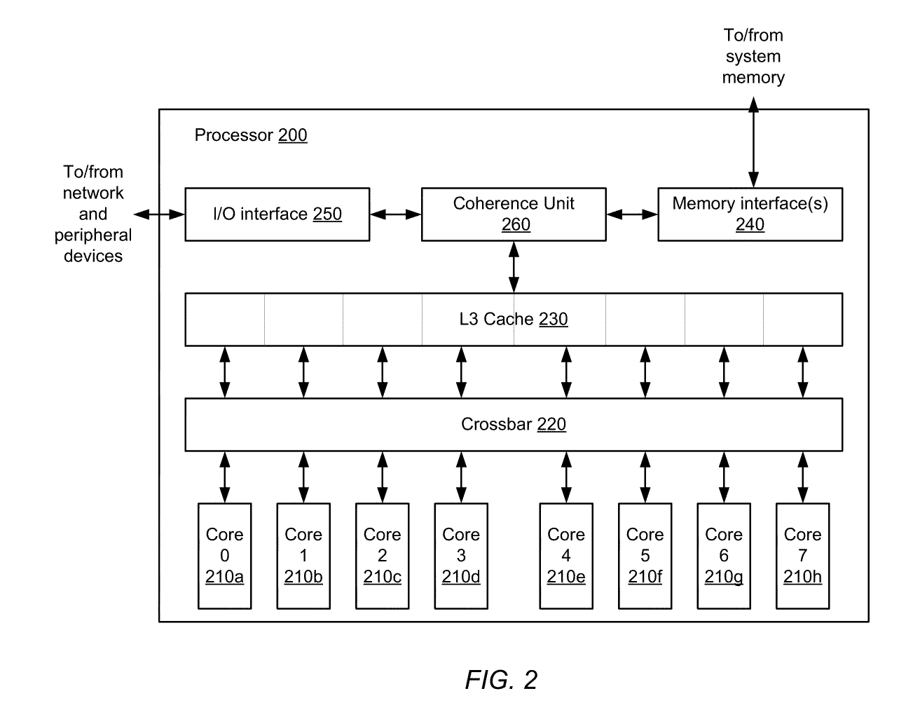

A block diagram illustrating one embodiment of a multithreaded processor 200 is shown in FIG. 2. In some embodiments, processor 200 may correspond to a given processor 120a-c of DCU 100 in FIG. 1. In the illustrated embodiment, processor 200 includes a plurality of processor cores 210a-h, which are also designated “core 0” though “core 7.” It is noted that although 8 cores are shown, in various embodiments, any suitable number of processor cores may be employed. Each of cores 210 is coupled to an L3 cache 230 via a crossbar 220. L3 cache 230 is coupled to coherence unit 260, which is in turn coupled to input/output (I/O) interface 250. Additionally, coherence unit 260 is coupled to one or more memory interface(s) 240, which are coupled in turn to one or more banks of system memory (not shown). As described in greater detail below, I/O interface 250 may couple processor 200 to peripheral devices, and a network. In some embodiments, the elements included in processor 200 may be fabricated as part of a single integrated circuit (IC), for example on a single semiconductor die.

Cores 210 may be configured to execute instructions and to process data according to a particular instruction set architecture (ISA). In one embodiment, cores 210 may be configured to implement the SPARC® V9 ISA, although in other embodiments it is contemplated that any desired ISA may be employed, such as x86, PowerPC® or MIPS®, for example. In the illustrated embodiment, each of cores 210 may be configured to operate independently of the others, such that all cores 210 may execute in parallel. Additionally, in some embodiments each of cores 210 may be configured to execute multiple threads concurrently, where a given thread may include a set of instructions that may execute independently of instructions from another thread. (For example, an individual software process, such as an application, may consist of one or more threads that may be scheduled for execution by an operating system.) Such a core 210 may also be referred to as a multithreaded (MT) core. In one embodiment, each of cores 210 may be configured to concurrently execute instructions from eight threads, for a total of 64 threads concurrently executing across processor 200. However, in other embodiments it is contemplated that other numbers of cores 210 may be provided, and that cores 210 may concurrently process different numbers of threads.

Crossbar 220 may be configured to manage data flow between cores 210 and the shared L3 cache 230. In one embodiment, crossbar 220 may include logic (such as multiplexers or a switch fabric, for example) that allows any core 210 to access any bank of L3 cache 230, and that conversely allows data to be returned from any L3 bank to any core 210. Crossbar 220 may be configured to concurrently process data requests from cores 210 to L3 cache 230 as well as data responses from L3 cache 230 to cores 210. In some embodiments, crossbar 220 may include logic to queue data requests and/or responses, such that requests and responses may not block other activity while waiting for service. Additionally, in one embodiment crossbar 220 may be configured to arbitrate conflicts that may occur when multiple cores 210 attempt to access a single bank of L3 cache 230.

L3 cache 230 may be configured to cache instructions and data for use by cores 210. In the illustrated embodiment, L3 cache 230 may be organized into eight separately addressable banks that may each be independently accessed, such that in the absence of conflicts, each bank may concurrently return data to a respective core 210. In some embodiments, each individual bank may be implemented using set-associative or direct-mapped techniques. For example, in one embodiment, L3 cache 230 may be a 48 megabyte (MB) cache, where each bank is 16-way set associative with a 64-byte line size, although other cache sizes and geometries are possible and contemplated. L3 cache 230 may be implemented in some embodiments as a writeback cache in which written (dirty) data may not be written to system memory until a corresponding cache line is evicted.

Memory interface 240 may be configured to manage the transfer of data between L3 cache 230 and system memory, for example, in response to L3 fill requests and data evictions. In some embodiments, multiple instances of memory interface 240 may be implemented, with each instance configured to control a respective bank of system memory. Memory interface 240 may be configured to interface to any suitable type of system memory, such as described above in reference to FIG. 1. In some embodiments, memory interface 240 may be configured to support interfacing to multiple different types of system memory.

In the illustrated embodiment, processor 200 may also be configured to receive data from peripheral devices rather than system memory. I/O interface 250 may be configured to provide a central interface for such devices to exchange data with cores 210 and/or L3 cache 230 via coherence unit 260. In some embodiments, I/O interface 250 may be configured to coordinate Direct Memory Access (DMA) transfers of data between external peripherals and system memory via coherence unit 260 and memory interface 240. Peripheral devices may include, without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, I/O interface 250 may implement one or more instances of an interface such as Peripheral Component Interface Express (PCI Express™), although it is contemplated that any suitable interface standard or combination of standards may be employed. For example, in some embodiments I/O interface 250 may be configured to implement a version of Universal Serial Bus (USB) protocol or IEEE 1394 (Firewire®) protocol in addition to or instead of PCI Express™.

I/O interface 250 may also be configured to coordinate data transfer between processor 200 and one or more devices (e.g., other computer systems) coupled to processor 200 via a network. In one embodiment, I/O interface 250 may be configured to perform the data processing in order to implement an Ethernet (IEEE 802.3) networking standard such as Gigabit Ethernet or 10-Gigabit Ethernet, for example, although it is contemplated that any suitable networking standard may be implemented. In some embodiments, I/O interface 250 may be configured to implement multiple discrete network interface ports.

The embodiment of the processor illustrated in FIG. 2 is an example merely for demonstrative purposes. In other embodiments, different configurations of components are possible and contemplated. For example, any suitable number of cores 210 may be included.

### Core Overview

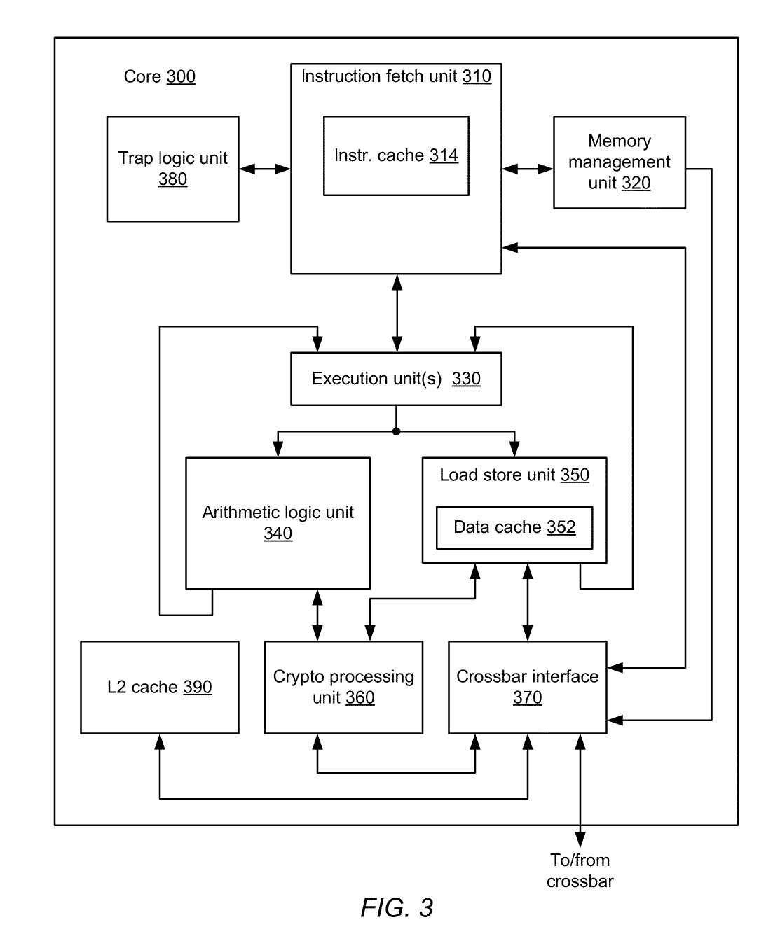

A possible embodiment of a core is illustrated in FIG. 3. Core 300 may correspond to a given core 210 in FIG. 2. In the illustrated embodiment, core 300 includes an instruction fetch unit (IFU) 310 coupled to a memory management unit (MMU) 320, a crossbar interface 370, a trap logic unit (TLU) 380, an L2 cache memory 390, and a plurality of execution units 330. Execution unit 330 is coupled to both an arithmetic logic unit (ALU) 340 and a load store unit (LSU) 350. Each of the latter units is also coupled to send data back to each of execution units 330. Both ALU 340 and LSU 350 are coupled to a crypto processing unit 360. Additionally, LSU 350, crypto processing unit 360, L2 cache memory 390 and MMU 320 are coupled to crossbar interface 370, which may in turn be coupled to crossbar 220 shown in FIG. 2.

Instruction fetch unit 310 may be configured to provide instructions to the rest of core 300 for execution. In the illustrated embodiment, IFU 310 may be configured to perform various operations relating to the fetching of instructions from cache or memory, the selection of instructions from various threads for execution, and the decoding of such instructions prior to issuing the instructions to various functional units for execution. Instruction fetch unit 310 further includes an instruction cache 314. In one embodiment, IFU 310 may include logic to maintain fetch addresses (e.g., derived from program counters) corresponding to each thread being executed by core 300, and to coordinate the retrieval of instructions from instruction cache 314 according to those fetch addresses. Additionally, in some embodiments IFU 310 may include logic to predict branch outcomes and/or fetch target addresses, such as a Branch History Table (BHT), Branch Target Buffer (BTB), or other suitable structure, for example.

In one embodiment, IFU 310 may be configured to maintain a pool of fetched, ready-for-issue instructions drawn from among each of the threads being executed by core 300. For example, IFU 310 may implement a respective instruction buffer corresponding to each thread in which several recently-fetched instructions from the corresponding thread may be stored. In some embodiments, IFU 310 may be configured to select multiple ready-to-issue instructions and concurrently issue the selected instructions to various functional units without constraining the threads from which the issued instructions are selected. In other embodiments, thread-based constraints may be employed to simplify the selection of instructions. For example, threads may be assigned to thread groups for which instruction selection is performed independently (e.g., by selecting a certain number of instructions per thread group without regard to other thread groups). In some embodiments, IFU 310 may be configured to further prepare instructions for execution, for example by decoding instructions, detecting scheduling hazards, arbitrating for access to contended resources, or the like. Moreover, in some embodiments, instructions from a given thread may be speculatively issued from IFU 310 for execution.

Execution unit 330 may be configured to execute and provide results for certain types of instructions issued from IFU 310. In one embodiment, execution unit 330 may be configured to execute certain integer-type instructions defined in the implemented ISA, such as arithmetic, logical, and shift instructions. It is contemplated that in some embodiments, core 300 may include more than one execution unit 330, and each of the execution units may or may not be symmetric in functionality. Finally, in the illustrated embodiment instructions destined for ALU 340 or LSU 350 pass through execution unit 330. However, in alternative embodiments it is contemplated that such instructions may be issued directly from IFU 310 to their respective units without passing through execution unit 330.

Arithmetic logic unit (ALU) 340 may be configured to execute and provide results for certain arithmetic instructions defined in the implemented ISA. For example, in one embodiment ALU 340 may implement single-precision and double-precision floating-point arithmetic instructions compliant with a version of the Institute of Electrical and Electronics Engineers (IEEE) 754 Standard for Binary Floating-Point Arithmetic (more simply referred to as the IEEE 754 standard), such as add, subtract, multiply, divide, and certain transcendental functions. Additionally, in one embodiment, ALU 340 may implement certain integer instructions such as integer multiply, divide, and population count instructions, and may be configured to perform multiplication operations on behalf of stream processing unit 240. Depending on the implementation of ALU 340, some instructions (e.g., some transcendental or extended-precision instructions) or instruction operand or result scenarios (e.g., certain denormal operands or expected results) may be trapped and handled or emulated by software.

In the illustrated embodiment, ALU 340 may be configured to store floating-point register state information for each thread in a floating-point register file. In one embodiment, ALU 340 may implement separate execution pipelines for floating-point add/multiply, divide/square root, and graphics operations, while in other embodiments the instructions implemented by ALU 340 may be differently partitioned. In various embodiments, instructions implemented by ALU 340 may be fully pipelined (i.e., ALU 340 may be capable of starting one new instruction per execution cycle), partially pipelined, or may block issue until complete, depending on the instruction type. For example, in one embodiment floating-point add operations may be fully pipelined, while floating-point divide operations may block other divide/square root operations until completed. In some embodiments, a floating-point unit may be implemented separately from ALU 340 to process floating-point operations while ALU340 handles integer and Boolean operations.

ALU 340 may also be configured to process both fixed and variable length machine independent numbers. Such numbers may be used in various applications, such as, e.g., databases, to allow numbers to be shared across different hardware platforms. In the illustrated embodiment, ALU 340 may be configured to change the representation of a number between two or more numeric formats. ALU 340 may include dedicated logic circuits for performing addition, multiplication, division and the like. ALU 340 may include such dedicated logic circuits for more than one type of numeric format. Including such dedicated logic circuits may, in some embodiments, improve performance of core 300 by eliminating a need to change an operand to a different numeric format between various arithmetic operations or by improving the efficiency of an arithmetic operation when the operands are in a given numeric format. In some embodiments, a numeric conversion unit may be implemented separately from ALU340 to handle numeric format conversions while ALU 340 processes arithmetic and Boolean operations.

Load store unit 350 may be configured to process data memory references, such as integer and floating-point load and store instructions as well as memory requests that may originate from crypto processing unit 360. In some embodiments, LSU 350 may also be configured to assist in the processing of instruction cache 314 misses originating from IFU 310. LSU 350 may include a data cache 352 as well as logic configured to detect cache misses and to responsively request data from L3 cache 230 via crossbar interface 370. In one embodiment, data cache 352 may be configured as a write-through cache in which all stores are written to L3 cache 230 regardless of whether they hit in data cache 352; in some such embodiments, stores that miss in data cache 352 may cause an entry corresponding to the store data to be allocated within the cache. In other embodiments, data cache 352 may be implemented as a write-back cache.

In one embodiment, LSU 350 may include a miss queue configured to store records of pending memory accesses that have missed in data cache 352 such that additional memory accesses targeting memory addresses for which a miss is pending may not generate additional L3 cache request traffic. In the illustrated embodiment, address generation for a load/store instruction may be performed by one of EXUs 330. Depending on the addressing mode specified by the instruction, one of EXUs 330 may perform arithmetic (such as adding an index value to a base value, for example) to yield the desired address. Additionally, in some embodiments LSU 350 may include logic configured to translate virtual data addresses generated by EXUs 330 to physical addresses, such as a Data Translation Lookaside Buffer (DTLB).

Crypto processing unit 360 may be configured to implement one or more specific data processing algorithms in hardware. For example, crypto processing unit 360 may include logic configured to support encryption/decryption algorithms such as Advanced Encryption Standard (AES), Data Encryption Standard/Triple Data Encryption Standard (DES/3DES), or Ron's Code #4 (RC4). Crypto processing unit 240 may also include logic to implement hash or checksum algorithms such as Secure Hash Algorithm (SHA-1, SHA-256), Message Digest 5 (MD5), or Cyclic Redundancy Checksum (CRC). Crypto processing unit 360 may also be configured to implement modular arithmetic such as modular multiplication, reduction and exponentiation. In one embodiment, crypto processing unit 360 may be configured to utilize the arithmetic functions included in ALU 340. In various embodiments, crypto processing unit 360 may implement several of the aforementioned algorithms as well as other algorithms not specifically described.

Crypto processing unit 360 may be configured to execute as a coprocessor independent of integer or floating-point instruction issue or execution. For example, in one embodiment crypto processing unit 360 may be configured to receive operations and operands via control registers accessible via software; in the illustrated embodiment crypto processing unit 360 may access such control registers via LSU 350. In such embodiments, crypto processing unit 360 may be indirectly programmed or configured by instructions issued from IFU 310, such as instructions to read or write control registers. However, even if indirectly programmed by such instructions, crypto processing unit 360 may execute independently without further interlock or coordination with IFU 310. In another embodiment crypto processing unit 360 may receive operations (e.g., instructions) and operands decoded and issued from the instruction stream by IFU 310, and may execute in response to such operations. That is, in such an embodiment crypto processing unit 360 may be configured as an additional functional unit schedulable from the instruction stream, rather than as an independent coprocessor.

L2 cache memory 390 may be configured to cache instructions and data for use by execution unit 330. In the illustrated embodiment, L2 cache memory 390 may be organized into multiple separately addressable banks that may each be independently accessed. In some embodiments, each individual bank may be implemented using set-associative or direct-mapped techniques. L2 cache memory 390 may be implemented in some embodiments as a writeback cache in which written (dirty) data may not be written to system memory until a corresponding cache line is evicted. L2 cache memory 390 may variously be implemented as single-ported or multi-ported (i.e., capable of processing multiple concurrent read and/or write accesses). In either case, L2 cache memory 390 may implement arbitration logic to prioritize cache access among various cache read and write requestors.

As previously described, instruction and data memory accesses may involve translating virtual addresses to physical addresses. In one embodiment, such translation may occur on a page level of granularity, where a certain number of address bits comprise an offset into a given page of addresses, and the remaining address bits comprise a page number. In such an embodiment, virtual to physical address translation may occur by mapping a virtual page number to a particular physical page number, leaving the page offset unmodified. Such a translation of mappings may be stored in an instruction translation lookaside buffer (ITLB) or a data translation lookaside buffer (DTLB) for rapid translation of virtual addresses during lookup of instruction cache 314 or data cache 352. In the event no translation for a given virtual page number is found in the appropriate TLB, memory management unit 320 may be configured to provide a translation. In one embodiment, MMU 320 may be configured to manage one or more translation tables stored in system memory and to traverse such tables (which in some embodiments may be hierarchically organized) in response to a request for an address translation, such as from an ITLB or DTLB miss. (Such a traversal may also be referred to as a page table walk.) In some embodiments, if MMU 320 is unable to derive a valid address translation, for example if one of the memory pages including a page table is not resident in physical memory (i.e., a page miss), MMU 320 may be configured to generate a trap to allow a memory management software routine to handle the translation. It is contemplated that in various embodiments, any desirable page size may be employed. Further, in some embodiments multiple page sizes may be concurrently supported.

A number of functional units in the illustrated embodiment of core 300 may be configured to generate off-core memory or I/O requests. For example, IFU 310 or LSU 350 may generate access requests to L3 cache 230 in FIG. 2 in response to their respective cache misses. Crypto processing unit 360 may be configured to generate its own load and store requests independent of LSU 350, and MMU 320 may be configured to generate memory requests while executing a page table walk. Other types of off-core access requests are possible and contemplated. In the illustrated embodiment, crossbar interface 370 may be configured to provide a centralized interface to the port of crossbar 220 in FIG. 2 associated with a particular core 210, on behalf of the various functional units that may generate accesses that traverse crossbar 220. In one embodiment, crossbar interface 370 may be configured to maintain queues of pending crossbar requests and to arbitrate among pending requests to determine which request or requests may be conveyed to crossbar 220 during a given execution cycle. For example, crossbar interface 370 may implement a least-recently-used or other algorithm to arbitrate among crossbar requestors. In one embodiment, crossbar interface 370 may also be configured to receive data returned via crossbar 220, such as from L3 cache 230 or I/O interface 250, and to direct such data to the appropriate functional unit (e.g., data cache 352 for a data cache fill due to miss). In other embodiments, data returning from crossbar 220 may be processed externally to crossbar interface 370.

During the course of operation of some embodiments of core 300, exceptional events may occur. For example, an instruction from a given thread that is picked for execution by pick unit 316 may be not be a valid instruction for the ISA implemented by core 300 (e.g., the instruction may have an illegal opcode), a floating-point instruction may produce a result that requires further processing in software, MMU 320 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit 380 may be configured to manage the handling of such events. For example, TLU 380 may be configured to receive notification of an exceptional event occurring during execution of a particular thread, and to cause execution control of that thread to vector to a supervisor-mode software handler (i.e., a trap handler) corresponding to the detected event. Such handlers may include, for example, an illegal opcode trap handler configured to return an error status indication to an application associated with the trapping thread and possibly terminate the application, a floating-point trap handler configured to fix up an inexact result, etc.

In one embodiment, TLU 380 may be configured to flush all instructions from the trapping thread from any stage of processing within core 300, without disrupting the execution of other, non-trapping threads. In some embodiments, when a specific instruction from a given thread causes a trap (as opposed to a trap-causing condition independent of instruction execution, such as a hardware interrupt request), TLU 380 may implement such traps as precise traps. That is, TLU 380 may ensure that all instructions from the given thread that occur before the trapping instruction (in program order) complete and update architectural state, while no instructions from the given thread that occur after the trapping instruction (in program order) complete or update architectural state.

The embodiment of the core illustrated in FIG. 3 is one of multiple contemplated examples. Other embodiments of a core may include a different number and configuration of components. For example, ALU 340 may be implemented as two or more separate functional blocks rather than a single unit.

### Number Formats

Processors, such as, e.g., processor 200 as illustrated in FIG. 2, represent numerical values in a grouping of bits commonly referred to as a computer number format or numeric format. Various encodings between a numeric value and a corresponding bit pattern are possible, and may depend on circuitry particular to a given processor. As such different processor implementations may have different representations of a given numeric value.

Some processors may allow for multiple numeric formats (also referred to herein as number formats). The choice of how a given number is represented within a processor may be controlled by software. For example, a user may elect to have a certain variable within a software program stored as a fixed-point number where a fixed number of bits are used to store the integer and fractional portions of a number. For example, in a 32-bit wide processor, 16-bits may be used to store the integer portion of a number, and 16-bits may be used to store the fractional portion of the number.

To allow for a greater range of numbers to be represented within a processor, a floating-point number format may be employed. A floating-point number format may include a series of bits encoding a mantissa (or significand), a series of bits encoding an exponent, and a sign bit. Using the mantissa, exponent, and sign together, a wide range of precision numbers may be represented within a processor. Various floating-point number formats are possible, such as, Institute of Electrical and Electronics Engineers (IEEE) 754-2008 standard.

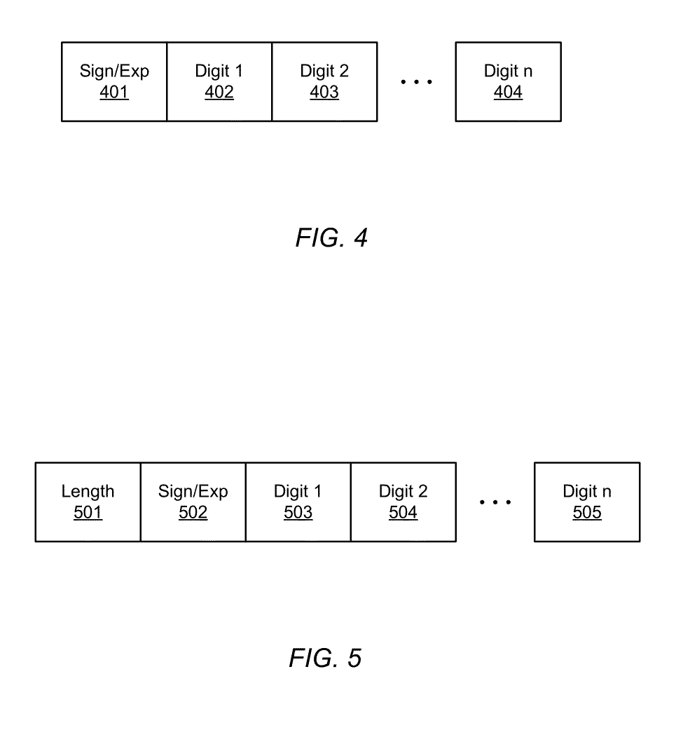

In some cases, however, the aforementioned number format may be translated from one computing system to another. For example, a numeric value represented by a 32-bit floating-point number in one computer system, may not be properly represented in a computer system, which supports 16-bit wide numbers. Moreover, some applications, such as, e.g., database storage and processing, may require specialized number formats. In such cases, a hardware independent number format may be employed. A block diagram depicting an embodiment of a machine-independent number format is illustrated in FIG. 4. In the illustrated embodiment, a numeric value is represented by a fixed number of mantissa digits (digit block 402 through digit block 404), and sign/exponent byte (sign/exp block 401).

Each mantissa digit (also referred to herein as a “digit”) may encode a single digit between 1 and 10 of the numeric values mantissa. It is noted that each mantissa digit may include any suitable number of data bits that may be needed for the encoding scheme employed. When four data bits are included for each digit, the number format may be referred to as binary-coded decimal (BCD). Each digit may, in various embodiments, correspond to a base-10 value between 0 and 9, respectively, resulting in an inherent addition of one into each mantissa digit. A negative number encoded in such a format may include digits, which are in a complement form, and have values between 2 and 11. In some embodiments, a complement of a digit may be created by subtracting the digit from a value of 12.

The use of a number such as the one depicted by the block diagram of FIG. 4 may, in some embodiments, allow for different computing systems, employing different inherent processor bit-widths, to perform computations on numbers without any translation between number formats. Software program instructions may be employed to allow a given processor within a computing system to process numbers represented in the machine-independent number format. Such program instructions may, in various embodiments, reduce system performance and computational throughput.

It is noted that the block diagram illustrated in FIG. 4 is merely one example. In other embodiments, different numbers of digits and different encoding schemes may be employed.

Another embodiment of a machine-independent number format is illustrated in FIG. 5. In the illustrated embodiment, a floating-point number is represented by a series of digit blocks (digit 503 through digit 505) of arbitrary length. Length block 501 encodes the number of digit blocks that are part of the floating-point number. Sign/exponent (also referred to herein as “sign and exponent”) block 502 is a collection of data that encodes the sign of the floating-point number as well as the exponent, i.e., the power of 100 by which the collective digit blocks are multiplied.

As with the embodiment described above in FIG. 4, each digit block (or mantissa digit) may be encoded with one of various digit formats. For example, rather than each digit block representing a value between 0 and 9 as discussed in regards to FIG. 4, each digit block of FIG. 5 may be encoded such that a single digit between 1 and 100 is used to store the value of the digit represented by each digit block. Each digit may, in various embodiments, correspond to a base-100 value between 0 and 99, respectively, resulting in an inherent addition of one into each mantissa byte. A negative number encoded in such a format may include digits, which are in a complement form, and have values between 2 and 101. In some embodiments, a complement of a digit may be created by subtracting the digit from a value of 102.

The value of the length byte may be adjusted or set dependent upon various arithmetic operations. Rounding or truncation operations may also affect the length byte of a number resulting from an arithmetic operation being performed on two or more operands.

The use of a number represented in a format such as the one illustrated in FIG. 5 may, in some embodiments, allow for different numbers to be represented with different precisions or accuracies dependent upon an application. For example, in some database applications, numbers in one portion of a database may require a certain accuracy, while numbers in another portion of a database may require a different accuracy.

It is noted that the number format illustrated in FIG. 5 is merely an example. In other embodiments, different numbers of digit blocks and different encoding schemes may be employed.

### Methods for Arithmetic

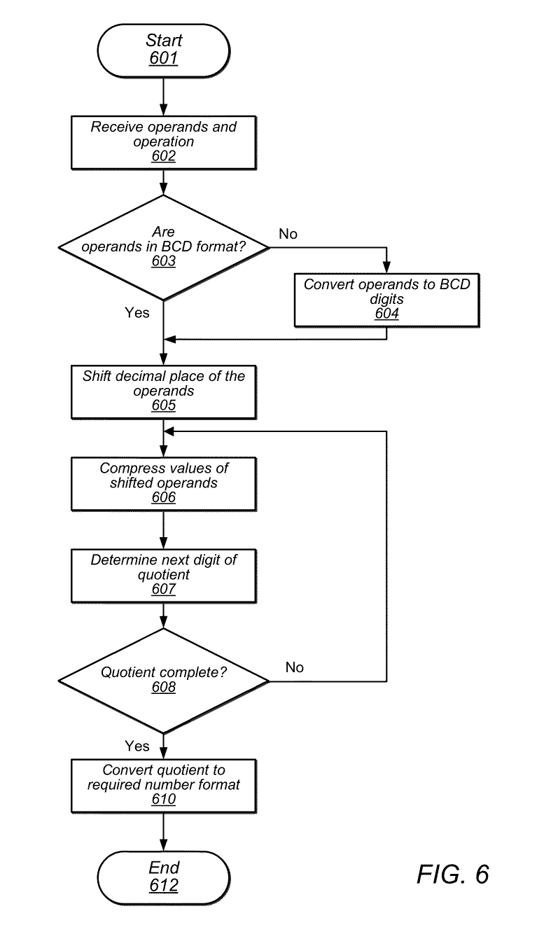

Turning to FIG. 6, an embodiment of a method for performing division is illustrated. In some embodiments, one or more of the following operations to perform division may be performed by an arithmetic logic unit, such as arithmetic logic unit (ALU) 340 in FIG. 3, for example. Referring collectively to core 300 in FIG. 3 and the flowchart of FIG. 6, the method begins in block 601.

Two operands may be received along with a divide operation command (block 602). Instruction fetch unit 310 may receive an instruction or command to perform a divide operation. In response to receiving the divide instruction, instruction fetch unit 310 may enable load store unit 350 to retrieve two operands dependent upon addressing values included with the divide instruction. ALU 340 may receive the divide instruction and the two operands retrieved by load store unit 350. The command may include a directive to perform the divide operation using operands in a specific number format, such as, for example, the binary-coded decimal format (BCD). The command may be received from execution unit 330, crypto processing unit 360, or another processor coupled to ALU 340.

The method may depend on the number format of the two operands (block 603). ALU 340 may verify that the received operands are in the specified number format. If one or both operands are not in the specified format, then the method may move to block 604 to convert one or both operands into the specified number format. In other embodiments, an error may occur, resulting in the method ending in block 612 and trap logic unit 380 handling the error condition. If both operands are in the specified number format, then the method may continue in block 605.

If at least one of the operands requires number format conversion, then that operand may be converted to the specified number format (block 604). In various embodiments, ALU 340 may perform the number format conversion, another block, such as a numeric conversion unit, may perform the conversion, or execution unit 330 may execute software instructions to perform the conversion.

ALU 340 may shift the decimal place of one or both operands (block 605). Shifting a decimal place of a BCD-formatted number by one BCD digit is equivalent to scaling a number by multiplying or dividing the number by a factor of ten. ALU 340 may determine if either operand needs to be scaled as part of the division operation. In some embodiments, the decimal places of the operands may be shifted in order to set the values of each operand between one and ten, i.e., aligned to the ones digit. For example, if one of the operands has a value of 34.5678, the value may be divided by ten to shift the decimal place to left, resulting in an operand value of 3.4678. Conversely, if an operand has a value of 0.87654, then the value may be multiplied by ten to shift the decimal place to the right, resulting in a value of 8.7654. If both operands have values between one and ten, then this scaling step may be skipped. Both scaled operands may be stored for later use before moving to the next step.

ALU 340 may compress the values of the scaled operands (block 606). As used and described herein, to compress a number is to reduce a number of data bits used to represent the number. The two operands may include a dividend, also referred to as a numerator, and a divisor, also referred to as a denominator. In some embodiments, to compress the numerator may include truncating the numerator to an integer value. In other words, a fractional part of the numerator may be removed for the current calculation. The removed fractional part of the numerator may be stored for later use. In a same embodiment, a fractional part of the denominator may be compressed into a fixed number of bits. Equations 1 show how two bits may be used to represent a range of fractional values.

00:0.25>fraction≧0.00

01:0.50>fraction≧0.25

10:0.75>fraction≧0.50

11:1.00>fraction≧0.75 (1)

As an example, if a shifted value of a denominator is 2.63333, then a fractional portion (0.63333) may be compressed to two bits as ‘10’ using equations 1. In other embodiments, three bits may be used, such as shown in Equations 2.

000:0.125>fraction≧0.000

001:0.250>fraction≧0.125

010:0.375>fraction≧0.250

011:0.500>fraction≧0.375

100:0.625>fraction≧0.500

101:0.750>fraction≧0.625

110:0.875>fraction≧0.750

111:1.000>fraction≧0.875. (2)

Returning to the example above, the fractional portion (0.63333) may be compressed to three bits as ‘101’ using equations 2. Other numbers of bits, and other bit encodings of two or three bits are known and contemplated.

Using the compressed operands, ALU 340 may estimate a next digit of a quotient of the divide operation (block 607). The quotient may be determined one digit at a time, starting with the most significant digit of the quotient. By using the compressed operands to estimate the next digit of the quotient, the calculations may be simpler, allowing for faster processing time and/or smaller, more power efficient circuitry in ALU 340. An estimated remainder may be determined using the compressed values. In some embodiments, values of the operands before compressing may be used to calculate an actual remainder value in parallel to validate the estimated digit of the quotient. In such embodiments, the actual remainder may be used for calculating a next digit of the quotient. Further details on how the estimation process works will be provided below in following figures.

The method may depend on the completeness of the quotient (block 608). In a given embodiment, for some operand values, the quotient may be complete when a remainder equals zero. In the same embodiment, for other operand values, the quotient may be limited to a fixed number of bits. The quotient may be determined to be complete when all allotted bits of the quotient are assigned values, even if the remainder is non-zero. Other methods for determining a quotient has reached an adequate level of completeness are known and contemplated. If the quotient is determined to be incomplete, then the method may return to block 606 to continue the calculation. The numerator may be replaced by the actual remainder from block 607 to calculate the next digit of the quotient. The new numerator may be shifted as described in block 605 before returning to block 606. Otherwise, if the quotient is complete, the method may convert a number format of the quotient in block 612.

If the quotient is required to be in a number format other than BCD, then the quotient may be converted to that number format (block 610). In some embodiments, the result of the divide operation may be in a BCD number format like the operands. In other embodiments, the quotient may be calculated in a different number format than BCD. If the quotient needs to be converted to a different number format, then, in various embodiments, ALU 340 may perform the number format conversion, another block, such as a numeric conversion unit, may perform the conversion, or execution unit 330 may execute software instructions to perform the conversion.

It is noted that the steps of the method illustrated in FIG. 6 are depicted as being performed in a sequential fashion. In other embodiments, one or more of the operations may be performed in parallel or additional steps may be included.

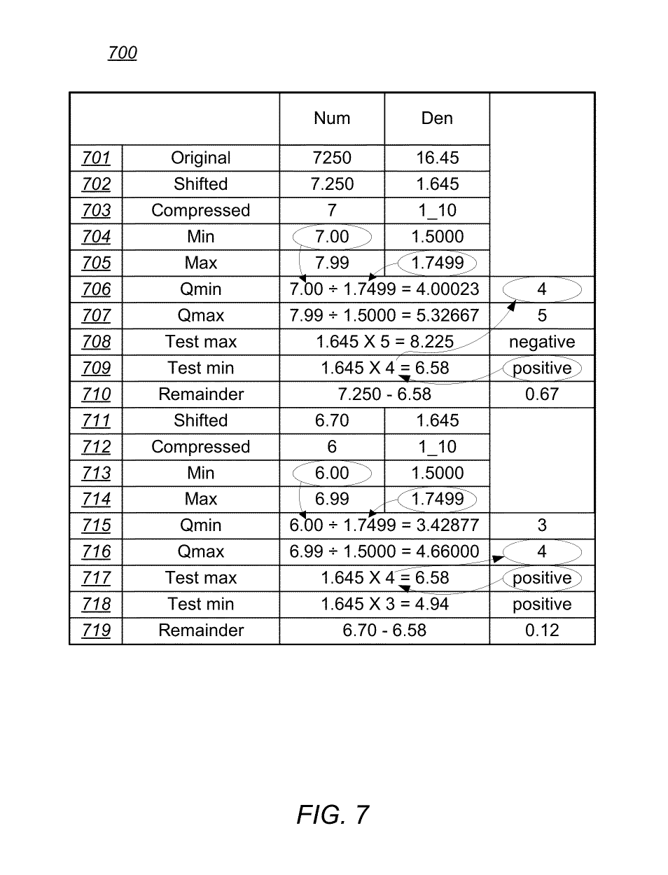

Moving now to FIG. 7, table 700 showing how the operand values are changed and used to calculate a quotient is illustrated. The values in table 700 may represent values associated with an arithmetic logic unit, such as ALU 340 in FIG. 3 for example, as ALU 340 performs a divide operation such as previously described in the blocks of the flowchart in FIG. 6.

Row 701 shows example values for two operands of a divide operation, a numerator value of 7250 and a denominator value of 16.45. In row 702, the two operands are shown as they may be set after a shift operation, such as described in block 605 above. The numerator value may be shifted to a value of 7.250 and the denominator shifted to a value of 1.645. The operands may then be compressed as shown in row 703, which may correspond to block 606. The numerator may be truncated to a value of 7 and the denominator may be compressed to 1_{—}10, wherein the ‘1’ is the ones digit and the ‘10’ binary value may correspond to a range of fractional values between 0.50 and 0.75 as described in Equation 1 above.

The compression step of row 703, may remove one or more less significant digits from the uncompressed operands. For example, if a numerator of value X is truncated to an integer value of Y, then the actual, non-truncated value of the numerator (X) may be Y≦X<Y+1. In the example of table 700, the minimum value of the truncated numerator may therefore be 7.00 and the maximum value may be chosen as 7.99, as shown in rows 704 and 705. The actual value of the numerator could be greater than 7.99 (e.g., the original value in row 701 could have been 7.996), but for the sake of simplifying calculations, 7.99 may provide enough accuracy in most calculations. As stated for block 607, a verification step may be included which might indicate if 7.99 produces an incorrect result.

Similarly for the denominator, minimum and maximum values may be determined from equation 1. Since the binary compressed value of the denominator is shown as ‘10’, then, using equation 1, the minimum value of the denominator may be 1.50 and the maximum value of the denominator may be 1.7499. Again, the maximum value could actually be higher than N+0.7499 (e.g., original denominator value in row 701 could have been 1.74994), but the determined value may provide enough accuracy and may be verified as in block 607.

Using the determined minimum and maximum values for the numerator and denominator from the example, minimum and maximum values for a first portion, i.e., digit, of the quotient may be determined. To determine a minimum quotient value (Qmin), the minimum value of the numerator may be divided by the maximum value of the denominator. Row 706 shows the results for the example of table 700, where Qmin is determined by dividing 7.00 by 1.7499 to get a result of 4.00023. Rounding to a single quotient digit, Qmin may be equal to 4. Similarly, to determine a maximum quotient value (Qmax), the maximum value of the numerator may be divided by the minimum value of the denominator. The results from the example are shown in row 707, where Qmax is determined by dividing 7.99 by 1.5000 to get a result of 5.32667. Again, rounding to a single digit, Qmax may be equal to 5.

Details of the additional rows of table 700 will be described later in conjunction with additional methods for performing a divide operation. It is noted that values used in table 700 of FIG. 7 are an example from one embodiment of ALU 340 and the method of FIG. 6. Other embodiments may utilize different numbers of significant digits and may use different methods for compressing the operands.

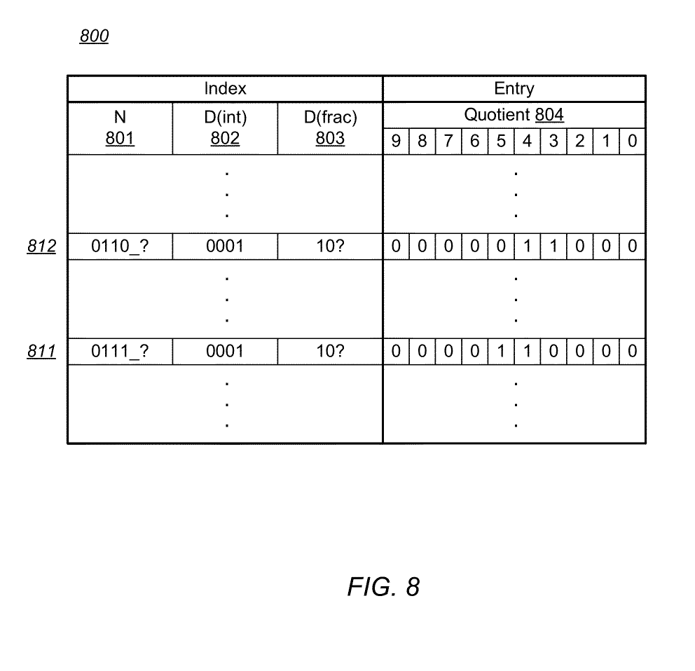

By shifting and compressing the values of the operands, a total number of possible combinations of numerator and denominator may be low enough such that a lookup table may be used to determine Qmax and Qmin for each of the possible combinations. If the lookup table is small enough, using the lookup table may provide a speed improvement versus calculating Qmax and Qmin for each digit of the quotient. Table 800 in FIG. 8 illustrates a partial embodiment of one such lookup table.

Lookup table 800 in FIG. 8, may correspond to a lookup table used by an arithmetic logic unit, such as, e.g., ALU 340 in FIG. 3 to implement a division method such as described in relation to the flowchart of FIG. 6. Lookup table 800 may include an index for selecting a corresponding table entry. The index may include values such as numerator (N) 801, an integer portion of a denominator [D(int)] 802, and a fractional portion of a denominator [D(frac)] 803. A number of entries, or rows, of the table may be limited by only including rows in which N 801 and D(int) 802 are valid BCD-formatted values. In other words, N 801 and D(int) may not have a value of, for example, 1100 as this may not be considered a valid BCD value. The table entries may include a bit field consisting of a number of ordered data bit positions to indicate possible quotient values (quotient 804) for the given inputs. Two rows are included from the example lookup table, 811 and 812, which may correspond to the example from table 700 in FIG. 7.

N 801 may include a first portion of the lookup table index and may include compressed values of possible numerators. The values may be represented as shown, using binary digits, and may further be encoded in a binary-decimal coded (BCD) format. A question mark (?) may be included to indicate the entry represents a truncated value. For example, in row 812, the N 801 value ‘0110_?’ may indicate a BCD formatted value of 6 with the fractional part of the numerator truncated. The ‘0110_?’ may then represent all numerator values from 6.00 to 6.99. As will be explained in more detail later, entries in other rows may include one or more binary digits in place of the ‘?’ to limit the value of the numerator for that entry.

D(int) 802 may include a second portion of the lookup table index may also be represented using binary digits encoded in a BCD format. D(int) values for both rows 811 and 812 are ‘0001’ which may represent a value of ‘1.’ D(frac) 803 may include a third portion of the lookup table index and may represent the fractional part of the denominator. The two-bit values of D(frac) 803 may correspond to the two-bit compressed values of Equation 1. The ‘?’ may indicate that two bits are provided in the corresponding entry. As with the entries for N 801, some entries of D(frac) 803 may include one or more additional bits in place of the ‘?.’ For example, a three bit value of D(frac) 803 may correspond to the three bit encodings of Equation 2. Further details will be provided below.

Output from lookup table 800 may include quotient 804. In various embodiments, quotient 804 may include multiple data bits in a specific order. For example, in the embodiment illustrated in FIG. 8, quotient 804 may include ten bits where each of the ten bits occupies a position labeled 9 through 0. The corresponding position of each bit of the ten bits may represent a single digit of the quotient of the numerator divided by the denominator. As was shown in table 700 of FIG. 7, compressed values of the numerator and denominator may allow for calculation of a minimum and maximum quotient (i.e., Qmin and Qmax, respectively). A ‘1’ in a given column of quotient 804, which may be referred to as an active bit, may indicate that the respective digit position (9 through 0) is a possible result of the corresponding numerator and denominator combination. A ‘0’ value in a column may be referred to as an inactive bit and may indicate the respective digit position is not a possible result for the given combination. If lookup table 800 is defined appropriately, then each row may be limited to two active bits per row, a first active bit to indicate a Qmax digit and a second active bit to indicate a Qmin digit.

In some embodiments, rather than using two active bits to indicate a Qmax digit and a Qmin digit, a single active bit may be used to indicate a Qmax digit only. In such an embodiment, Qmin may only be needed if a test of Qmax results in a negative remainder. Qmin may then be determined by subtracting ‘1’ from the indicated Qmax value.

Referring back to table 700, an example of how lookup table 800 might be utilized may be presented. In rows 706 and 707, Qmin and Qmax are calculated using the min and max values of the numerator and denominator. Division operations, however, in a computing system may take multiple instruction cycles. Using lookup table 800 may provide a more efficient method for determining Qmin and Qmax. Row 703 shows a compressed value of 7 for the numerator and a compressed value of 1_{—}10 for the denominator. Using these compressed values as the index to lookup table 800, a numerator of 7 may correspond to a value of 0111_? for N 801, an integer portion of the denominator of 1 may correspond to a value of 0001 for D(int) 802, and a fractional portion of the denominator of 10 may correspond to a value of 10? for D(frac) 803. These index values for N 801, D(int) 802 and D(frac) 803 correspond to row 811 in this example. Possible quotient digits are indicated by the ‘1’ values in the ‘5’ and ‘4’ columns. Qmax may be determined to be 5 and Qmin may be determined to be 4, corresponding to the calculated values in rows 707 and 706, respectively.

It is noted that lookup table 800 in FIG. 8 only illustrates a portion of the total entries that would fill a fully populated lookup table. It is also noted that other embodiments of a lookup table may be organized in a different way and may include values encoded in different number formats and including various numbers of significant digits.

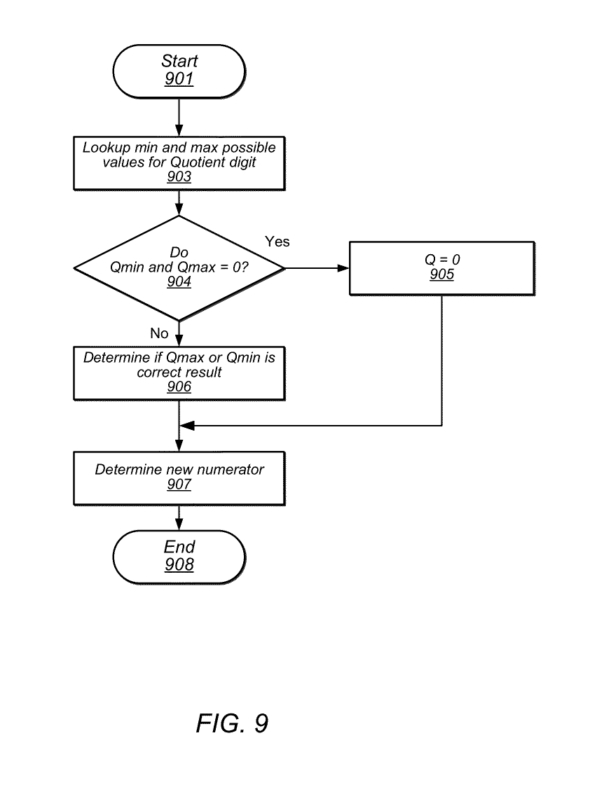

Moving now to FIG. 9, a flowchart depicting an embodiment of a method for estimating a portion of a quotient (Q) of a divide operation is illustrated. In some embodiments, a portion of the quotient may be equivalent to a single BCD formatted digit. The method of FIG. 7 may, in some embodiments, correspond to block 607 of the method of FIG. 6 and may be performed by an arithmetic logic unit, such as ALU 340 in FIG. 3. Referring collectively to core 300 in FIG. 3 and the flowchart of FIG. 9, the method begins in block 901 with a numerator and denominator both shifted and compressed as described in relation to FIG. 6.

Values for a minimum value of Q (Qmin) and a maximum value of Q (Qmax) may be determined from a lookup table (block 903). As described in relation to FIG. 8, a lookup table, such as, e.g., lookup table 800, may be utilized as part of a method for dividing values. A table input value or address may be created by appending a compressed value of a denominator to the end of a compressed value of the numerator. In other embodiments, the numerator value may be appended to the denominator value. Using the created address, a value may be read from the lookup table, which may indicate Qmin and Qmax values for the provided numerator and denominator.

The method may depend upon the values of Qmin and Qmax (block 904). ALU 340 may check if both Qmin and Qmax equal zero. In such a case, further calculations for the current quotient digit may be unnecessary as Q may be assigned a value of ‘0’ (block 905) and the method may then proceed to block 907. If, however, either Qmin or Qmax are non-zero values, then the method may move to block 906 to determine which value, Qmin or Qmax should be assigned to Q.

A value of Q may be determined as either Qmin or Qmax (block 906). If the lookup table has been defined such that only two possible values of Q are indicated by a given entry, then Q may be determined as either Qmin or Qmax. A more detailed explanation of determining the correct value of Q will be presented in relation to the next figure below.

A new numerator value may be determined based on the determined value of Q (block 907). Once Q has been determined, a new numerator may be determined by subtracting Q times the denominator from the current numerator. In other words, the remainder may be used to determine the new numerator. The method may end in block 908.

It is noted that method illustrated in FIG. 9 is merely an example. In other embodiments, different operations and different orders of operations are possible and contemplated. For example, more steps may be included to determine if Qmax or Qmin is the correct result.

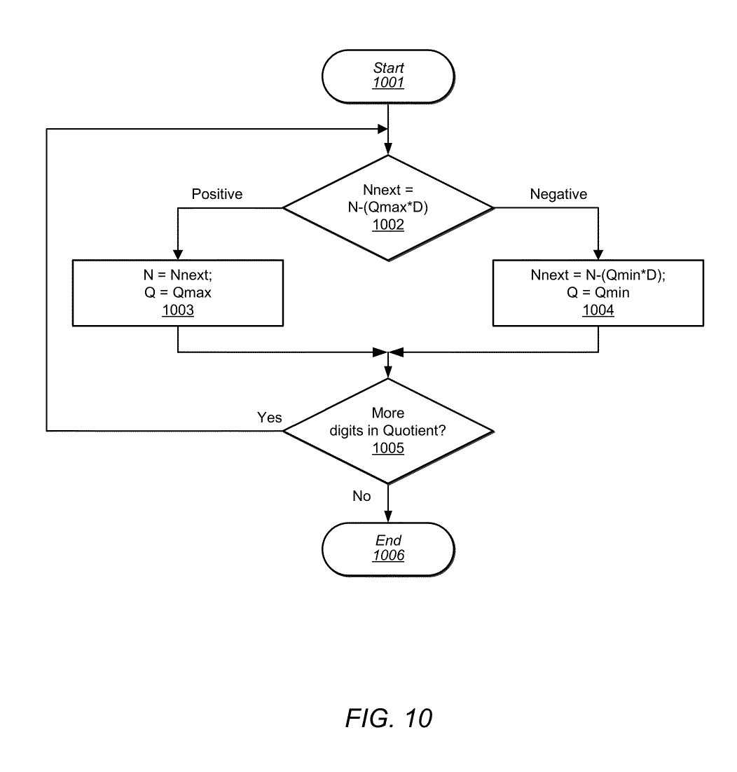

Turning to FIG. 10, a flowchart for a method to determine a current digit of a quotient in a divide operation is illustrated. In some embodiments, the method illustrated in FIG. 10 may correspond to block 906 and block 907 of the flowchart illustrated in FIG. 9 and may be performed by an arithmetic logic unit, such as ALU 340 in FIG. 3. Referring collectively to core 300 in FIG. 3 and the flowchart of FIG. 10, the method begins in block 1001.

The method may depend upon the result of a calculation using the determined value of Qmax (block 1002). If values for Qmax and Qmin have not been determined, then Qmax and Qmin may be determined, for example, by using a lookup table such as lookup table 800. A remainder value may be calculated by multiplying Qmax by the denominator and subtracting the product from the numerator. As an example, refer back to table 700 in FIG. 7. In row 708, Qmax may be tested as a value for Q by multiplying Qmax (5) by the denominator (1.645) to determine a product of 8.225. Subtracting the product (8.225) from the numerator (7.250) results in a negative number.

If the result of the remainder using Qmax is negative, then the method may move to block 1004 to repeat the calculation with Qmin. Otherwise, the method may move to block 1003.

If the result of block 1002 is positive, then Q may be set to Qmax and a new numerator may be determined (block 1003). Q may be set equal to Qmax and a new value of the numerator may be set equal to the remainder value determined in block 1002. The new numerator value may be shifted one decimal place to the left in preparation for calculating a next digit of the quotient. In some embodiments, before the new numerator is shifted, a check may be made to determine if Q has been set to an erroneous value. This check may include verifying that the remainder is less than the maximum value of the denominator. A remainder greater than the maximum value of the denominator may indicate an error in the calculation, possibly due to the compression step in block 606 of FIG. 6.

If the result of block 1002 is negative, then Q may be set to Qmin and a new numerator may be determined (block 1004). A new remainder may be calculated by multiplying Qmin by the denominator and subtracting the product from the numerator. Referring back to table 700, row 709 may show a result of such a calculation. Qmin (4) is multiplied by the denominator (1.645) to determine a product of 6.58. Subtracting the product (6.58) from the numerator (7.250) results in a positive number of 0.67 for the remainder as shown in row 710. In some embodiments, the remainder may be shifted one decimal place to the left to determine a new numerator. In row 711 of the example, a new numerator with a value of 6.70 is determined.

The method may depend on a determination that more digits are required to complete the quotient (block 1005). Each determined value of Q may represent a portion, i.e., a single BCD formatted digit, of the final quotient. To determine an overall quotient for the original operands, the determined values of Q may be concatenated together such that the first calculated value of Q is the most significant digit of the quotient and the last value of Q is the least significant digit. Several factors may be used to determine if the most recent calculated value of Q is the final digit to be calculated. If the remainder equals zero in either block 1002 or block 1004, then any remaining digits of the quotient will be zero and the method may terminate in block 1006. If the quotient has reached a threshold number of digits, then the method may terminate in block 1006. The threshold may be a predetermined limit on the number of digits or may be a physical limitation of the circuitry of ALU 340. In some embodiments, the threshold may be determined by the number of significant digits provided in the original operands. If more digits of the quotient are to be calculated, then the method may return to block 1002 to determine the next digit using the new numerator value. Otherwise, the method may end in block 1006.

It is noted that the method illustrated in FIG. 10 is merely an example. Different operations and different orders of operations may be employed in various other embodiments. For example a verification step may be included to check if a possible erroneous value as been determined.

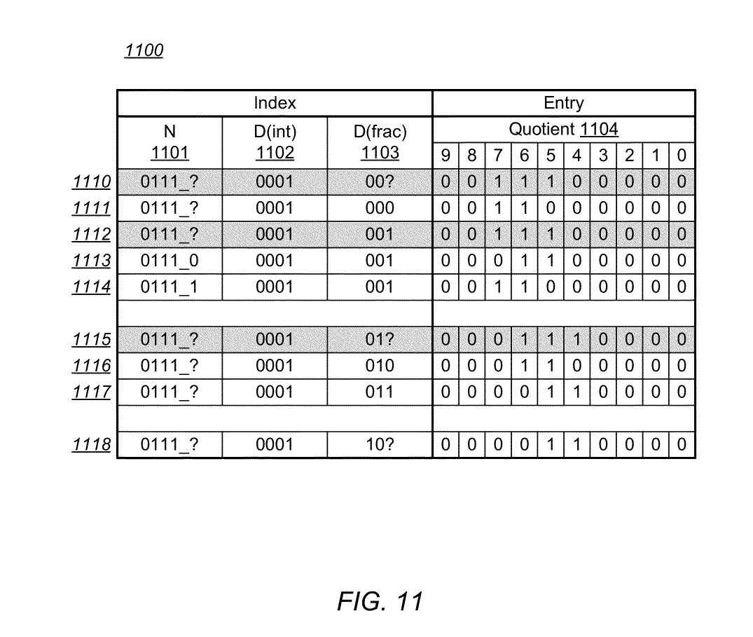

Moving to FIG. 11, a portion of rows of lookup table 1100 is illustrated. Lookup table 1100 may include similar data as lookup table 800 in FIG. 8. N 1101, D(int) 1102, D(frac) 1103, and quotient 1104 may correspond to N 801, D(int) 802, D(frac) 803, and quotient 804 in FIG. 8. Row 1118 may correspond to row 811 in FIG. 8.

In the description of FIG. 8, it was stated that if lookup table 800 is defined appropriately, each row may be limited to two active bits per row, a first active bit to indicate a Qmax digit and a second active bit to indicate a Qmin digit. In some embodiments of lookup table 1100, most rows may be limited to one or two active bits for quotient 1104. However, due to the compression of the numerator and denominator, some rows may have more than two active bits in quotient 1104. For example, lookup table 1100 shows two rows for which more than two active bits are returned in quotient 1104. In row 1115, the value for N is 0111_?, the value of D(int) is 0001 and the value of D(frac) is 01?. For this combination of inputs, Qmin is 4 and Qmax is 6, leaving 5 as a third possible value of Q between 4 and 6. In some embodiments, having three possible values for Q may be acceptable and row 1115 may remain in lookup table 1100. In other embodiments, having three possible values for Q may not be acceptable and therefore the table entries may be adjusted to compensate.

To reduce row 1115 to two possible values of Q, this row may be sub-divided into two rows. One way to accomplish this sub-division may be to expand D(frac) from two bits to three bits, using the bit encodings of Equation 2. Row 1116 shows D(frac) with a value of 010, which, from Equation 2, may correspond to a range of fractional values from 0.25 to 0.375. Adding this extra bit to D(frac) may reduce the possible values of Q to a Qmin of 5 and a Qmax of 6. Row 1117 shows D(frac) with a value of 011 which may correspond to fractional values from 0.375 to 0.500. With these fractional values, the possible values of Q may be limited to a Qmin of 4 and a Qmax of 5. In this case, row 1115 may be removed from lookup table 1100 and replaced by rows 1116 and 1117.

In some cases, however, adding the third bit to D(frac) may not be enough to eliminate occurrences of three possible values for Q. Row 1110 illustrates such an example. In row 1110, N 1101 is 0111_?, the value of D(int) is 0001 and the value of D(frac) is 00?. For this combination of inputs, Qmin is 5 and Qmax is 7, and 6 is a third possible value of Q. In row 1111, adding a third bit to D(frac) may result in a value of D(frac) equal to 000, which may correspond to fractional values from 0.000 to 0.125. These values may limit quotient 1104 to a Qmin value of 6 and a Qmax value of 7. In row 1112, D(frac) is 0 which may correspond to fractional values from 0.125 to 0.250. These values may still result in three possible values for Q.

To further narrow the possible values of Q down to two per row, an extra bit may be added to N 1101. The value included in N 1101 may typically be a whole number portion of the compressed numerator value. An extra bit corresponding to a fractional value may be added to limit the range of possible values of the compressed numerator value, thereby limiting the number of potential values of Q. In row 1113, the value of N 1101 has been changed from 0111_? to 0111_{—}0. The former value may correspond to a range of values from 7.00 to 7.99. The new value may limit this range of values to 7.00 to 7.49. Combining the new limited range of N 1101 with the values for D(int) 1102 and D(frac) 1103 (0001 and 001, respectively), quotient 1104 may now be limited to two results, Qmin equal to 5 and Qmax equal to 6. Similarly, in row 1114, N 1101 has been changed to 0111_{—}1, which may correspond to a range of values from 7.50 to 7.99. Combining this range of numerator values with the values for D(int) 1102 and D(frac) 1103 (0001 and 001, respectively), quotient 1104 may again be limited to two results, Qmin equal to 6 and Qmax equal to 7. In this case, row 1110 may be removed from lookup table 1100 and replaced by rows 1111, 1113 and 1114. Row 1112 may not be included in table 1100 since it includes three possible results.

It is noted that lookup table 1100 of FIG. 11 is merely an example for demonstrative purposes. In other embodiments, other number formats may be utilized, such as hexadecimal or octal. Also, in other embodiments, organization of the lookup table may be different to suit the needs of a particular system.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus, comprising:
a fetch unit configured to retrieve a first operand and a second operand responsive to receiving an instruction, wherein a value of the first operand and a value of the second operand each include respective binary-coded decimal (BCD) values;
an arithmetic logic unit (ALU) configured to:
scale the value of the first operand and the value of the second operand to generate a first scaled value and a second scaled value, respectively;
compress the first scaled value and the second scaled value to generate a first compressed value and a second compressed value, respectively;
wherein a number of data bits included in the first compressed value is less than a number of data bits included in the first scaled value, and a number of data bits included in the second compressed value is less than a number of data bits included in the second sclaed value; and
estimate a portion of a result of the operation dependent upon the first compressed value and the second compressed value.

2. The apparatus of claim 1, further comprising a lookup table, wherein the lookup table includes a plurality of entries, and wherein to estimate the portion of the result of the operation, the ALU is further configured to select a given one of the plurality of entries dependent upon the first compressed value and the second compressed value.

3. The apparatus of claim 2, wherein to estimate the portion of the result of the operation, the ALU is further configured to determine a minimum possible value for the portion of the result and a maximum possible value for the portion of the result dependent upon the given one of the plurality of entries.

4. The apparatus of claim 3, wherein the ALU is further configured to determine the portion of the result of the operation dependent upon the minimum possible value for the portion of the result and the maximum possible value for the portion of the result.

5. The apparatus of claim 1, wherein the first scaled value and the second scaled value are each greater than or equal to one and less than ten.

6. The apparatus of claim 2, wherein each entry of the plurality of entries includes a plurality of data bits, wherein each one of the plurality of data bits occupies a respective one of a plurality of ordered data bit positions, wherein a data bit position of an active data bit corresponds to the portion of the result of the operation.

7. The apparatus of claim 1, wherein to compress the second scaled value to generate the second compressed value, the ALU is further configured to compress a fractional portion of the second scaled value to generate a compressed fractional portion, wherein a number of data bits included in the compressed fractional portion is less than or equal to three.

8. A method, comprising:
receiving a first operand, a second operand, and an operation, wherein a value of the first operand and a value of the second operand each include respective binary-coded decimal values;
scaling the value of the first operand and the value of the second operand to generate a first scaled value and a second scaled value, respectively;
compressing the first scaled value and the second scaled value to generate a first compressed value and a second compressed value, respectively;
wherein a number of data bits included in the first compressed value is less than a number of data bits included in the first scaled value, and a number of data bits included in the second compressed value is less than a number of data bits included in the second scaled value; and
estimating a portion of a result of the operation dependent upon the first compressed value and the second compressed value.

9. The method of claim 8, wherein estimating the portion of the result of the operation comprises selecting, from a lookup table, a given one of a plurality of entries dependent upon the first compressed value and the second compressed value.

10. The method of claim 9, wherein to estimate the portion of the result of the operation comprises determining a minimum possible value for the portion of the result and a maximum possible value for the portion of the result dependent upon the given one of the plurality of entries.

11. The method of claim 10, further comprising determining the portion of the result of the operation dependent upon the minimum possible value for the portion of the result and the maximum possible value for the portion of the result.

12. The method of claim 8, wherein the first scaled value and the second scaled value are each greater than or equal to one and less than ten.

13. The method of claim 9, wherein each entry of the plurlaity of entries includes a plurality of data bits, wherein each one of the plurality of data bits occupies a respective one of a plurality of ordered data bit positions, wherein a data bit position of an active data bit corresponds to the portion of the result of the operation.

14. The method of claim 8, wherein compressing the second scaled value to generate the second compressed value further comprises compressing a fractional portion of the second scaled value to generate a compressed fractional portion, wherein a number of data bits included in the compressed fractional portion is less than or equal to three.

15. A system, comprising:
a processor;
a memory configured to store one or more program instructions; and
an interface configured to couple the processor and the memory;
wherein the processor is configured to:
retrieve a first operand, a second operand, and an operation dependent upon at least one of the one or more program instructions;
scale the value of the first operand and the value of the second operand to generate a first scaled value and a second scaled value, respectively;
compress the first scaled value and the second scaled value to generate a first compressed value and a second compressed value, respectively;
wherein a number of data bits included in the first compressed value is less than a number of data bits included in the first scaled value, and a number of data bits included in the second compressed value is less than a number of data bits included in the second scaled value; and
estimate a portion of a result of the operation dependent upon the first compressed value and the second compressed value.

16. The system of claim 15, wherein to estimate the portion of the result of the operation, the processor is further configured to select, from a lookup table, a given one of a plurality of entries dependent upon the first compressed value and the second compressed value.

17. The system of claim 16, wherein to estimate the portion of the result of the operation, the processor is further configured to determine a minimum possible value for the portion of the result and a maximum possible value for the portion of the result dependent upon the given one of the plurality of entries.

18. The system of claim 17, wherein the processor is further configured to determine the portion of the result of the operation dependent upon the minimum possible value for the portion of the result and the maximum possible value for the portion of the result.

19. The system of claim 15, wherein to retrieve the first operand and the second operand, the processor is further configured to convert the value of the first operand and the value of the second operand from a first number format to a second number format.

20. The system of claim 19, wherein the processor is further configured to convert a value of the result of the operation from the second number format to the first number format.
